(19) United States
(12) Patent Application Publication
(10) Pub. No.: US 2023/0144861 A1
(43) Pub. Date: May 11, 2023

(54) METHOD FOR UNIFORMIZATION OF FLOW FOR STIMULATION OPERATIONS

(71) Applicant: Petróleo Brasileiro S.A. - Petrobras, Rio de Janeiro (BR)

(72) Inventors: Mario Germino Ferreira Da Silva, Rio de Janeiro (BR); Alexandre Zacarias Ignacio Pereira, Rio de Janeiro (BR); Paulo Dore Fernandes, Rio de Janeiro (BR)

(21) Appl. No.: 17/983,606

(22) Filed: Nov. 9, 2022

(30) Foreign Application Priority Data
Nov. 11, 2021 (BR) 10 2021 022762 1

(51) Int. Cl. C09K 8/74

(52) U.S. Cl. CPC C09K 8/74

(57) ABSTRACT

The invention proposes a tool for flow uniformization in stimulation operations that uses a washing string with divergent perforation, provides a better direction of stimulation and, therefore, a better management of the reservoir.

The technology can be applied entirely through the wells area, being addressed to the reservoirs area in the management of reservoirs; wells stimulated in a homogeneous way will have fewer problems of premature cones of water and/or gas, and in the lift and flow area will contribute to improving the guarantee of flow of production from the wells. It can be applied as a technology in the intervention of wells in the phase of restoration of productivity, through operations of injection of acid in the reservoir as well as operations of squeeze of scale inhibitor. In this way, the application of the technology creates ease for the management of scaling for producing wells, and it can also be applied in injecting wells to improve the efficiency of sweeping in the reservoir and in the recovery of the injectivity index.

### FIELD OF THE INVENTION

The present invention is related to the field of management of oil producing wells, more directed to the stimulation of wells in a homogeneous way. The field of application will be the production development area in reservoir management, production loss control through production management.

### DESCRIPTION OF THE STATE OF THE ART

In horizontal wells drilled and completed in carbonate reservoirs, during the drilling process, an intrinsic damage is produced at the reservoir well interface, thus reducing the permeability at this interface; for this reason, at the completion base, stimulation is needed to improve well productivity.

In the case of horizontal producing and injecting wells, these normally, when stimulated, inject with greater flow rate in the section closest to the beginning of the horizontal length of the well, normally the shoe of the last liner. Given that this flow distribution is not homogeneous, along the length of the horizontal well there may be more injection/stimulation of the initial section of the well close to the shoe of the last liner and, therefore, the treatment is not distributed homogeneously along the horizontal length of the well.

Depending on the type of reservoir, the wells will be completed with specific equipment to meet the well completion project. When these wells are drilled in carbonate formations, in the specific case of Marlim Leste, for example, perforated liners were used to complete the wells; however, the liners installed in Marlim Leste did not have a liner perforation project that would promote flow uniformization of the wells along the horizontal length of the wells.

The experience of Petrobras and several studies have shown that the production flow does not occur uniformly along a horizontal well (DIKKEN, B. J. Pressure drop in horizontal wells and its effect on production performance. SPE 19824-PA. Journal of Petroleum Technology, November 1990, 1426; Trans., AIME, 289; PENMATCHA, V. R., ARBABI, S., AZIZ, K. Effects of Pressure Drop in Horizontal Wells and Optimum Well Length. SPE 37494-MS. SPE Journal, September 1990, 215; JANSEN, J. D. A semianalytical model for calculating pressure drop along horizontal wells with stinger completions. SPE 74212-PA. SPE Journal, June 2003, p. 138). Due to the pressure drop and permeability distribution, there is a flow gradient along the entire zone of interest. This characteristic of the production profile can lead to problems such as the premature arrival of water or gas, which, in turn, can reduce the recovery factor of the Field.

Basically, there are two different approximations in reservoir flow analysis. One suggests the use of infinite conductivity, neglecting hydraulics effects, leading to overestimation of production and not considering the flow distribution. This approximation seems to be reasonable for low productivity systems, where the pressure drops of the well could be neglected when compared to the pressure drops that occur in the porous medium (VICENTE, R., SARICA, C., ERTEKIN, T. Horizontal Well Design Optimization: A Study of the Parameters Affecting the Productivity and Flux Distribution of a Horizontal Well. SPE 84194-MS. SPE Annual Technical Conference and Exhibition, Colorado, USA, October 2003). However, for wells with a long horizontal section, with high production flow rates, reduced diameter, heavy oil or multiphase flow, the well hydraulics becomes a very important variable.

Vicente and others considered a finite approximation of conductivity, including, in their model, the effects of pressure drop, acceleration, gravity and reservoir inflow, representing a more realistic model proposal for this type of system, which allowed the analysis of different flow effects along a horizontal stretch (VICENTE, R., SARICA, C., ERTEKIN, T. Horizontal Well Design Optimization: A Study of the parameters Affecting the Productivity and Flux Distribution of a Horizontal Well. SPE 84194-MS. SPE Annual Technical Conference and Exhibition, Colorado, USA, October 2003).

It is often found in the literature and in applications of the oil industry the consideration of infinite conductivity related to horizontal wells (F. J. Kuchuk, P. A. Goode, D. J. Wilkinson, R. K. M. Thambynayagam. Pressure-Transient Behavior of Horizontal Wells With and Without Gas Cap or Aquifer. Paper Number: SPE-17413-PA. SPE Form Eval 6 (01): 86-94, 1991), in which the pressure drop in the horizontal well is considered to be negligible when compared to the pressure differential (drawdown) in the reservoir. In other words, the well is considered a “point” in the reservoir. This hypothesis, although it brings savings in computational terms, implies deviations in the estimation of production values.

Authors such as Ozkan et al. (1993) report that the concept of infinite conductivity can be applied in a restricted way to low production systems, where the flow pressure through the well is negligible in relation to the pressure field generated in the reservoir (drawdown). Even so, they state that, for situations where horizontal wells and reservoirs present the same magnitude of pressure drop, the production and flow distribution are strongly influenced by the pressure drops in the well (OZKAN, E., SARICA, C., HACI, M. The Influence of Pressure Drop along the Wellbore on Horizontal Well Productivity. SPE 57193-PA. SPE Journal, September 1999).

The adverse consequences on the efficiency of the production process are well known, with great impact on the recovery and primary processing of oil.

The document “DE SOUZA RIBEIRO, Heitor Lopes; ROMERO, Oldrich Joel. Estudo da furacao diversiva em pocos horizontais produtores de petróleo. Research, Society and Development, v. 8, no. 10, p. e248101362-e248101362, 2019” discloses a simulation performed using commercial software of computational fluid dynamics, with the objective of analyzing the pressure drop in the flow of a horizontal pipe, arising from the interference of a radial inflow from the holes in the pipe.

The document “MANTEGAZINI, Isabela Silva; ROMERO, Oldrich Joel. Análise do escoamento em pocos horizontais injetores completados com a técnica de furacão diversiva. Research, Society and Development, v. 8, no. 9, p. e50891327-e50891327, 2019” discloses a computational fluid dynamics simulation using a horizontal pipeline with differentiated perforation to analyze the flow in horizontal injection wells completed with the divergent perforation technique, highlighting the effects of inertial and viscous forces on the pressure drop profile and, consequently, on the flow profile.

Document U.S. Pat. No. 7,841,398B2 discloses a method and devices for gravel packing and an open-hole wellbore. The apparatus includes a sand screen disposed in the wellbore, thereby creating a ring between the well and the sand screen. The device further includes a tubular member or wash pipe which is arranged concentrically in the sand screen to receive carrier fluid passing through the sand screen and to return the carrier fluid to the earth's surface. At least one valve is installed on the tubular member to allow the flow of the carrier fluid into the tubular member.

Wash pipes are similar to production string pipes, but have some important differences: variable steel grade, defined linear weight, high torque resistant special thread and have the outer diameter smaller than the well diameter or the smallest liner thereof. The wash pipe is used in oil well fishing operations. In document U.S. Pat. No. 7,841,398, the purpose is different, for gravel packing operations.

The presented anteriorities address only to unproven simulations and do not present wash pipes with divergent perforation to uniformize the flow of a fluid and stimulate the production of the oil well.

In view of the difficulties present in the above-mentioned state of the art, and for solutions to uniformize the flow for stimulation operations, there arises the need of developing a technology capable of performing effectively and that is in accordance with environmental and safety guidelines. The above-mentioned state of the art does not have the unique features that will be presented in detail below.

### Objective of the Invention

It is an objective to promote the stimulation of a horizontal well so that the injection flow is uniform along the length of the well.

It is an objective of the invention to make it possible to reduce the risk of acid flowback from the rig during the assembly of the stimulation string.

It is still an objective of the invention to improve the sweeping efficiency in the reservoir with injection wells.

It is further an objective of the invention to facilitate the management of scaling in producing wells.

### BRIEF DESCRIPTION OF THE INVENTION

The invention proposes a method and a tool for flow uniformization in stimulation operations that uses a washing string (wash pipe) with divergent perforation, provides a better direction of stimulation and therefore a better reservoir management. The wash pipe used in the state of the art is intended to carry out fishing operations in oil wells. In the case of the present invention, the wash pipes were applied for stimulation of the well and also to avoid the possibility of getting stuck within the production string of the well.

The technology can be applied integrally through the area of wells, being addressed to the area of reservoirs in the management of reservoirs; the wells stimulated in a homogeneous way will have less problems of premature cones of water and/or gas, and in the area of lift and flow will contribute to improve the guarantee of flow of production from the wells. It can be applied as a technology in the intervention of wells in the phase of restoration of productivity, through operations of injection of acid in the reservoir as well as operations of squeeze of scale inhibitor. In this way, the application of the technology creates ease for the management of scaling for production wells, and it can also be applied in injection wells to improve the efficiency of sweeping in the reservoir and in the recovery of the injectivity index.

### BRIEF DESCRIPTION OF DRAWINGS

The present invention will be described in more detail below, with reference to the attached figures which, in a schematic way and not limiting the inventive scope, represent examples of its embodiment. In the drawings, there are:

FIG. 1 illustrates the effect of permeability;

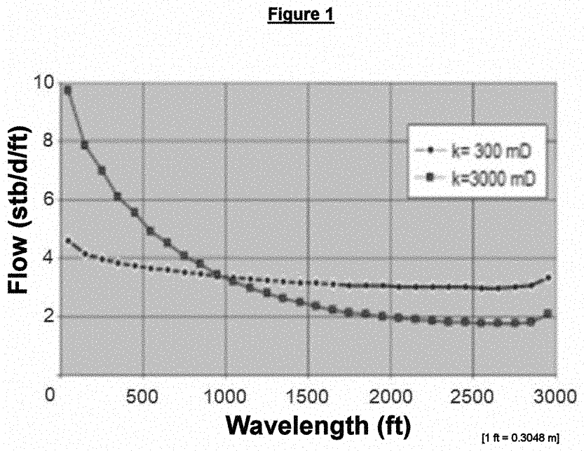

FIG. 2 illustrates the effect of flow on the flow profile;

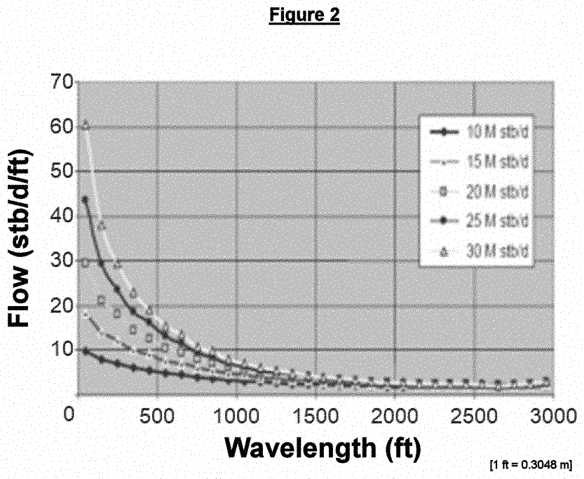

FIG. 3 illustrates a schematic of the distribution profile of the sweeping in the injection well at the beginning of the injection, injecting (bottom) and producing (top) pair;

FIG. 4 illustrates an overlap profile of the distribution of the sweeping in injection well on the production of the producing well, injecting (bottom) and producing (top) pair, RF is the field recovery factor that increases proportionally with the increase in sweeping efficiency;

FIG. 5 illustrates the distribution of homogeneous flow between the sweeping of the injecting well and drainage of the producing well, injecting (bottom) and producing (top) pair, RF is the field recovery factor that increases proportionally with the increase in sweeping efficiency;

FIG. 6 illustrates the uniform steam flow scheme;

FIG. 7 illustrates a graph of a well's peak production history;

FIG. 8 illustrates the first stage of acidification, the string removed and measuring until the upper seals were inside the Swell Packer, the acidification of the first stage carried out with closed BOP;

FIG. 9 illustrates the second acidification stage, the lower 4.75″ (12.07 cm) seals positioned on the lower Swell Packer and the upper 4.75″ (12.07 cm) seals positioned on the upper Swell Packer, the second acidification stage carried out;

FIG. 10 illustrates the third stage of acidification, the lower 4.75″ (12.07 cm) seals positioned in the upper Swell Packer, the pipe ram closed and the third stage of acidification carried out.

### DETAILED DESCRIPTION OF THE INVENTION

There follows below a detailed description of a preferred embodiment of the present invention, by way of example and in no way limiting. Nevertheless, it will be clear to a technician skilled on the subject, from reading this description, possible further embodiments of the present invention still comprised by the essential and optional features below.

Before the invention, the wells were completed with conventional equipment, which did not have a flow uniformization design in the production string along the horizontal length of the wells, and were stimulated with conventional tools that did not promote flow uniformization. Normally, depending on the tool, a string was used and, at the end, there was a flow system between two types of wash cups that treated the horizontal length of the well in small intervals and thus continued until the entire horizontal length of the well was completed. There were risks associated with the occurrence of acid flowback during maneuvers on the rotary table in the rig, the rig time to perform the treatment was very long, which made the operation more expensive in financial terms due to the use of critical resources.

The stimulation method using the wash string is described below:
use of information from the horizontal well, such as: length and diameter, viscosity and API grade of oil;
use of information from the reservoir, such as: static pressure and flow pressure;
use of the wash pipe tool to stimulate the reservoir;
performance of the stimulation of the reservoir with the wash pipe tool with divergent perforation during the stage of completion of the oil or natural gas well. Stimulation can be acidic, with solvents or scale inhibitors.

Acids can be organic or inorganic, such as hydrochloric acid, acetic acid, and formic acid, for example. Solvents to be used are, for example: diesel, xylene, butyl glycol. Inhibitors can be DTPA (ethylene triaminopentacetic acid) and EDTA (ethylenediamine tetraacetic acid). That is, chemicals and solvents usually used in well stimulation.

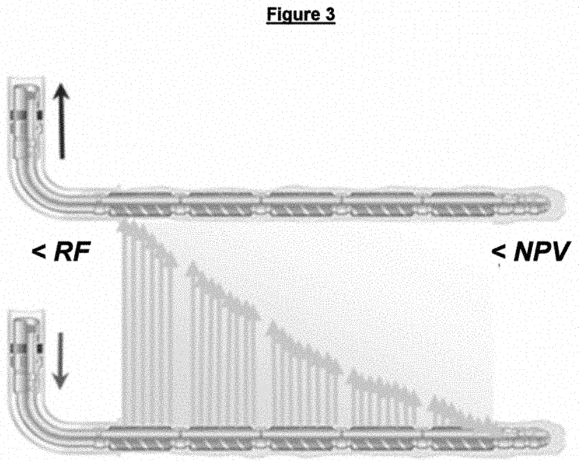

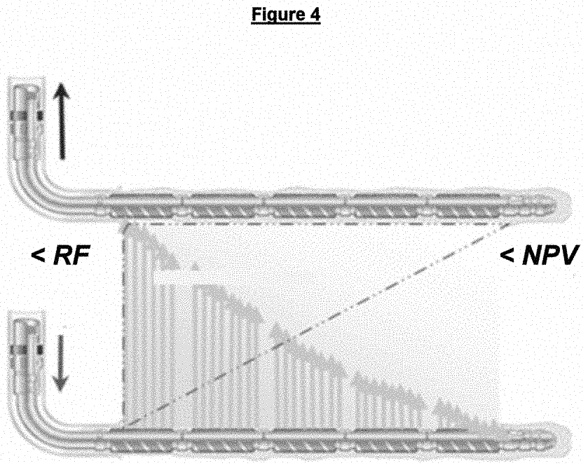

FIGS. 3 and 4 represent the generic flow profiles, expected for wells without equalization. It can be seen that, without flow uniformization, the expectation of recovery leads to a lower NPV due to the tendency towards premature breakthrought.

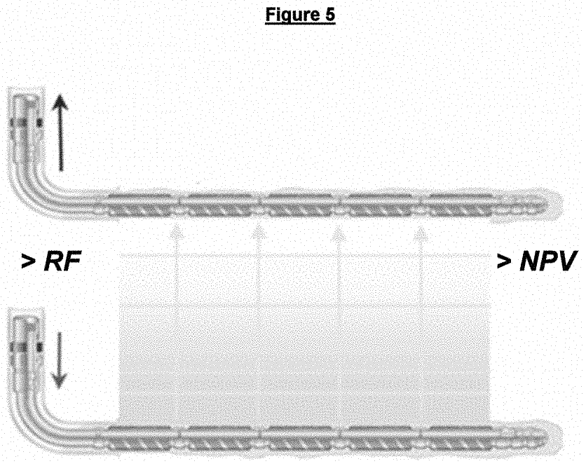

FIG. 5, in turn, represents the expected gain from the equalization of the production-injection system, with the following improvements:
Increase in the useful life of the well;
Improvement of the recovery factor;
Increase in the efficiency of the water injection process;
Obtaining an NPV closer to the foreseen.

Even so, it is important that there is prior knowledge of the flow distribution in the horizontal well to:
Check if there is a need for uniformization;
Design the appropriate uniformization system.

Although FIG. 5 is an optimistic representation, intermediate and even so quite attractive results can be obtained, improving the management of the fields.

### Examples

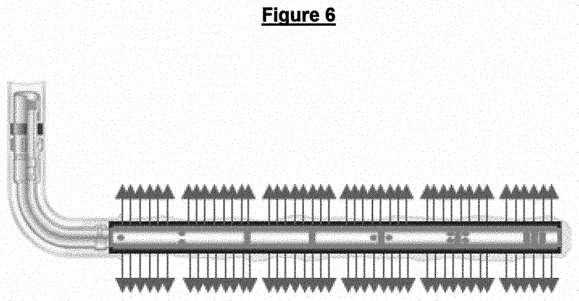

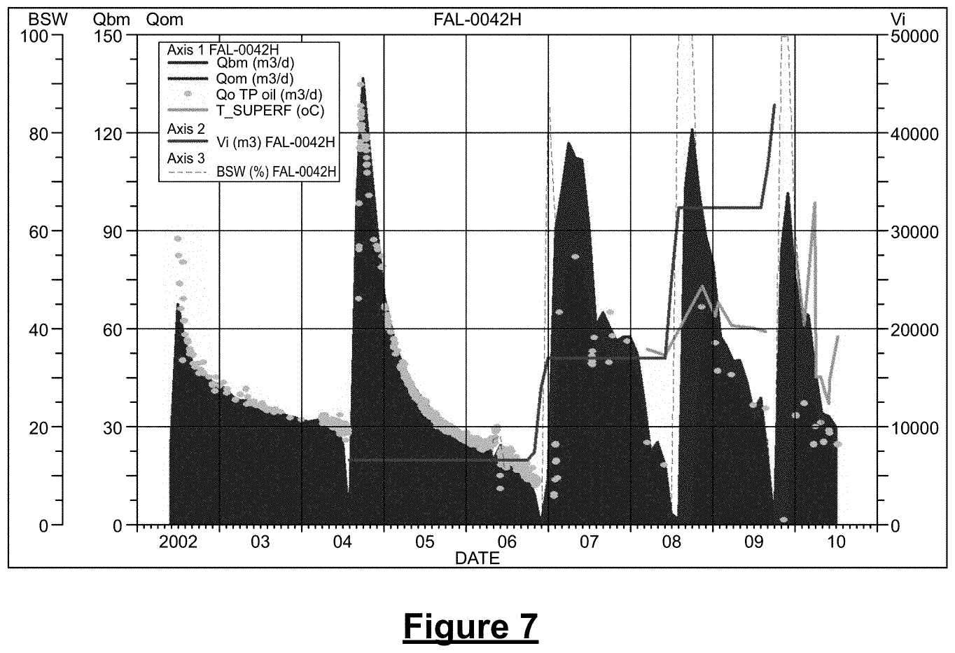

At one operational unit, flow uniformization was employed to improve steam distribution in the wells. Wash pipes with divergent perforation were used in the cyclic injection of steam in a single horizontal producing well, in the range of 919.5 to 1318 m. FIGS. 6 and 7 illustrate the use of wash pipes and the flow distribution curves obtained. The graph records the production of the well without steam injection, followed by three cycles of steam injection and oil production, and the steam injection using the technology of divergent wash pipes was carried out in the fifth cycle. It was evaluated that the production was close to what was expected for the conventional injection, thus indicating that the test should be carried out in the first cycle of a well to obtain a better measurement of the result in relation to the conventional one.

In this way, the wells were equipped with conventional perforated wash pipes and the treatment was carried out in stages of a 500-m interval, using the wash pipes instead of the liner (production string), without any restrictions on production of the wells being noted.

Its application in the well provided production flow rates of about 6900 m³/day in a carbonate formation. The other wells in this field were treated using the same technique, also obtaining the same treatment efficiency.

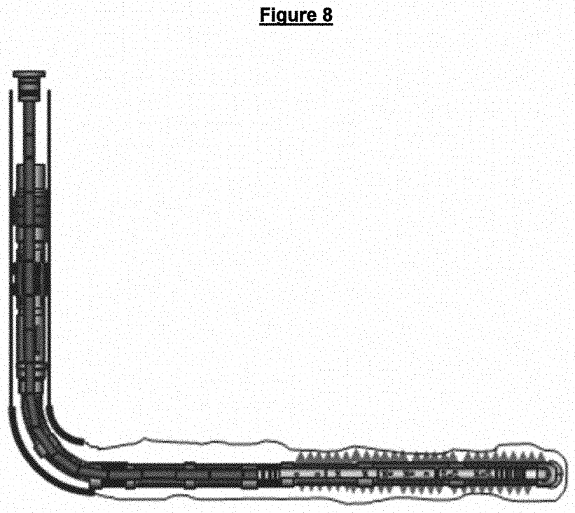

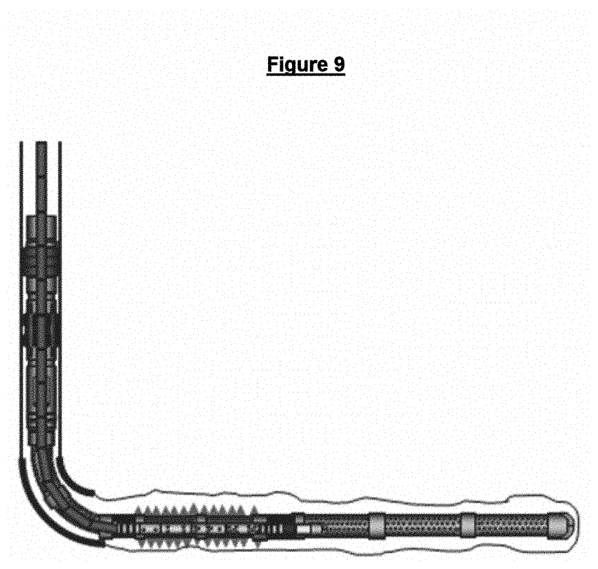

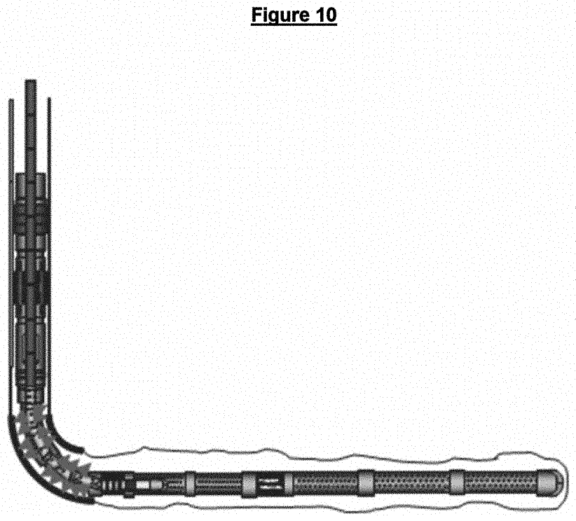

The application of the technique resulted in a time gain of 60 h in the stimulation operation compared with acidification via flexitube. FIGS. 8 to 10 show the treatment with wash pipes performed after the liner was run in. At the end of the treatment, the wash pipes were removed from the well to run in the production string.

The invention is formed by the use of information from the horizontal well, such as: length and diameter, to be used to calculate the length of the wash pipe string; viscosity; the API grade. From the reservoir, there is used information, such as: static pressure and flow pressure, to be used to calculate in the simulator the pressure drop distribution that will be applied to generate flow uniformization during the acid injection.

The solution achieved by the use of the tool (wash string) promotes homogeneous stimulation, with a distribution of the injection flow of acid, solvent or scale removers evenly along the horizontal length of the wells. This solution meets the need for stimulation with homogeneous flow for horizontal wells, aiming at increasing productivity for producing wells and increasing sweep efficiency for injection wells, through a flow uniformization process in the stimulation of horizontal wells and/or vertical wells or directional with large net pays lengths between producing intervals. In the case of horizontal producing and injecting wells, these normally produce or inject with greater flow rate in the section closest to the beginning of the horizontal length of the well, normally the shoe of the last liner.

1- A METHOD FOR UNIFORMIZATION OF FLOW FOR STIMULATION OPERATIONS, characterized in that it:
uses information from the horizontal well, such as: length and diameter, viscosity and API grade of oil;
uses information from the reservoir, such as: static pressure and flow pressure;
uses the wash pipe tool to stimulate the reservoir;
performs reservoir stimulation with the wash pipe tool with divergent perforation during the well completion.

2- THE METHOD FOR UNIFORMIZATION OF FLOW FOR STIMULATION OPERATIONS according to claim 1, characterized in that it calculates the length of the string of wash pipes as a function of the length and diameter of the well.

3- THE METHOD FOR UNIFORMIZATION OF FLOW FOR STIMULATION OPERATIONS according to claim 1, characterized in that, from the static pressure and flow pressure, it calculates, in the simulator, the pressure drop distribution that will be applied to generate the flow uniformization during the acid injection.

4- THE METHOD FOR UNIFORMIZATION OF FLOW FOR STIMULATION OPERATIONS according to claim 2, characterized in that the wash pipe tool is a perforated pipe, capable of promoting a uniform flow along the horizontal length of the well.

5- THE METHOD FOR UNIFORMIZATION OF FLOW FOR STIMULATION OPERATIONS according to claim 1, characterized in that it uses acids, solvents or scale removers to stimulate the oil well.

6- THE METHOD FOR UNIFORMIZATION OF FLOW FOR STIMULATION OPERATIONS according to claims 1 and 5, characterized in that it uses hydrochloric acid or acetic acid or formic acid or mixtures thereof for acid stimulation.

7- THE METHOD FOR UNIFORMIZATION OF FLOW FOR STIMULATION OPERATIONS according to claims 1 and 5, characterized in that it uses diesel or xylene or butyl-glycol or mixtures thereof as solvents.

8- THE METHOD FOR UNIFORMIZATION OF FLOW FOR STIMULATION OPERATIONS according to claims 1 and 5, characterized in that it uses DTPA (ethylene triaminopentacetic acid) or EDTA (ethylenediamine tetraacetic acid) as scale removers.
